(19) United States
(12) Patent Application Publication
(10) Pub. No.: US 2022/0065645 A1
(43) Pub. Date: Mar. 3, 2022

(54) ROUTE DETERMINATION SYSTEM, ROUTE DETERMINATION METHOD, AND ROUTE DETERMINATION PROGRAM

(71) Applicant: Toyota Jidosha Kabushiki Kaisha, Toyota-shi Aichi-ken (JP)

(72) Inventors: Kunihiro Iwamoto, Nagakute-shi Aichi-ken (JP); Yuta Itozawa, Nagoya-shi (JP); Hirotaka Komura, Anjo-shi Aichi-ken (JP)

(73) Assignee: Toyota Jidosha Kabushiki Kaisha, Toyota-shi Aichi-ken (JP)

(21) Appl. No.: 17/410,280

(22) Filed: Aug. 24, 2021

(30) Foreign Application Priority Data
Aug. 26, 2020 (JP) 2020-142463

(51) Int. Cl. G01C 21/34; G01C 21/36; G06Q 10/08; G06T 17/05

(52) U.S. Cl. CPC G01C 21/3469; G01C 21/3492; G06T 17/05; G06Q 10/0832; G01C 21/3691

(57) ABSTRACT

A route determination system determines a transport route for an autonomous mobile body to transport an article from among a plurality of candidates. The system includes an acquisition unit that acquires setting information related to necessity of at least one of cooling retention and heat retention of the article and an extraction unit that extracts, for each of the plurality of candidates, a low-temperature environment part in which a temperature in a delivery environment of the article along the candidate is estimated to be lower than temperatures of other parts of the candidate when the setting information about the cool retention is acquired, and a route determination unit that determines the transport route from among the plurality of candidates so that the temperature in the delivery environment of the article becomes low based on a length of the low-temperature environment part.

### CROSS REFERENCE TO RELATED APPLICATIONS

This application is based upon and claims the benefit of priority from Japanese patent application No. 2020-142463, filed on Aug. 26, 2020 the disclosure of which is incorporated herein in its entirety by reference.

### BACKGROUND

The present disclosure relates to a route determination system, a route determination method, and a route determination program.

Japanese Unexamined Patent Application Publication No. 2002-96913 discloses a technique in which a measurement value and position information of a sensor are recorded on an electronic tag of a delivery article, and the recorded data is used to improve the delivery service. According to the technique disclosed in Japanese Unexamined Patent Application Publication No. 2002-96913, it is possible to select a route with less vibration using the history in which the position information of a vehicle is associated with vibration data.

### SUMMARY

In this case, there is a problem that power consumption increases when an article is delivered while being frozen or kept warm.

The present disclosure achieves a method for determining a transport route of an autonomous mobile body capable of reducing power consumption when an article needs to be transported while being frozen or kept warm.

A route determination system according to the present disclosure is for deciding a transport route for an autonomous mobile body to transport an article on from among a plurality of candidates. The route determination system includes:

an acquisition unit configured to acquire setting information related to necessity of at least one of cooling retention and heat retention of the article;

an extraction unit configured to extract, for each of the plurality of candidates, a low-temperature environment part in which a temperature in a delivery environment of the article along the candidate is estimated to be lower than temperatures of other parts of the candidate when the setting information about the cool retention is acquired, or a high-temperature environment part in which the temperature is estimated to be higher than temperatures of other parts of the candidate when the setting information about the heat retention is acquired; and

a route determination unit configured to determine the transport route from among the plurality of candidates so that the temperature in the delivery environment of the article becomes low based on a length of the low-temperature environment part when the setting information about the cool retention is acquired, and determine the transport route from among the plurality of candidates so that the temperature in the delivery environment of the article becomes high based on a length of the high-temperature environment part when the setting information about the thermal insulation is acquired.

A route determination method according to the present disclosure is for deciding a transport route for an autonomous mobile body to transport an article on from among a plurality of candidates. The route determination method includes:

acquiring setting information related to necessity of at least one of cooling retention and heat retention of the article;

extracting, for each of the plurality of candidates, a low-temperature environment part in which a temperature in a delivery environment of the article along the candidate is estimated to be lower than temperatures of other parts of the candidate when the setting information about the cool retention is acquired, or a high-temperature environment part in which the temperature is estimated to be higher than temperatures of other parts of the candidate when the setting information about the heat retention is acquired; and

determining the transport route from among the plurality of candidates so that the temperature in the delivery environment of the article becomes low based on a length of the low-temperature environment part when the setting information about the cool retention is acquired, and determining the transport route from among the plurality of candidates so that the temperature in the delivery environment of the article becomes high based on a length of the high-temperature environment part when the setting information about the thermal insulation is acquired.

A route determination program according to the present disclosure is for deciding a transport route for an autonomous mobile body to transport an article on from among a plurality of candidates. The route determination program causes a computer to execute:

acquiring setting information related to necessity of at least one of cooling retention and heat retention of the article;

extracting, for each of the plurality of candidates, a low-temperature environment part in which a temperature in a delivery environment of the article along the candidate is estimated to be lower than temperatures of other parts of the candidate when the setting information about the cool retention is acquired, or a high-temperature environment part in which the temperature is estimated to be higher than temperatures of other parts of the candidate when the setting information about the heat retention is acquired; and

determining the transport route from among the plurality of candidates so that the temperature in the delivery environment of the article becomes low based on a length of the low-temperature environment part when the setting information about the cool retention is acquired, and determining the transport route from among the plurality of candidates so that the temperature in the delivery environment of the article becomes high based on a length of the high-temperature environment part when the setting information about the thermal insulation is acquired.

According to the present disclosure, it is possible to reduce power consumption when an article needs to be transported while being frozen or kept warm.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a configuration diagram showing a configuration example of a route determination system according to a first embodiment;

FIG. 2 is a block diagram showing a functional configuration of a server according to the first embodiment;

FIG. 3 is a schematic diagram showing an example of a transport route determined by the route determination system according to the first embodiment;

FIG. 4 is a flowchart showing an operation of the route determination system according to the first embodiment;

FIG. 5 is a configuration diagram showing a configuration of a route determination system according to a second embodiment;

FIG. 6 is a block diagram showing a functional configuration of a server according to the second embodiment;

FIG. 7 is a schematic diagram showing an example of a transport route determined by the route determination system according to the second embodiment;

FIG. 8 is a configuration diagram showing a configuration example of a route determination system according to a third embodiment;

FIG. 9 is a configuration diagram showing a functional configuration of a server according to the third embodiment; and

FIG. 10 is a schematic diagram showing an example of a transport route determined by a route determination system according to the third embodiment.

### DESCRIPTION OF EMBODIMENTS

### First Embodiment

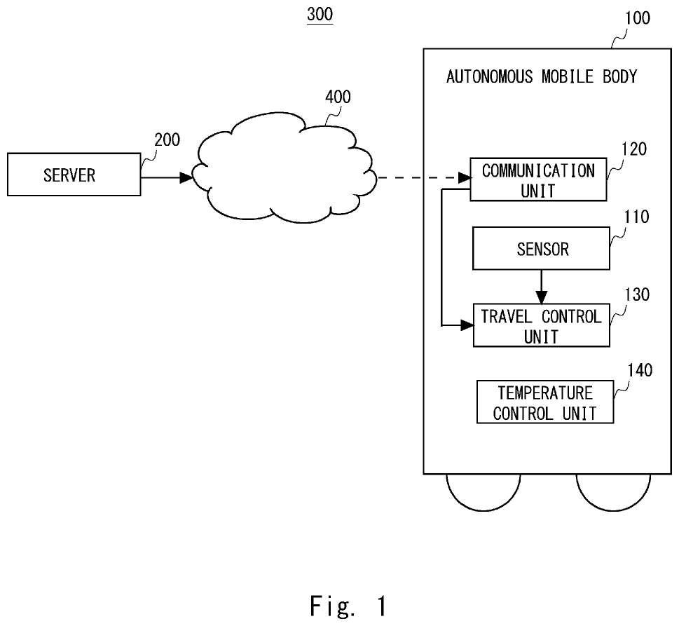

Embodiments of the present disclosure will be described below with reference to the drawings. FIG. 1 is a configuration diagram showing a configuration example of a route determination system 300 according to a first embodiment. The route determination system 300 includes a server 200 and an autonomous mobile body 100.

The autonomous mobile body 100 may be an automatic drive vehicle traveling on a roadway or a smaller delivery robot traveling on a sidewalk. The autonomous mobile body 100 autonomously moves along a predetermined transport route to deliver a package. The autonomous mobile body 100 and the server 200 are connected to each other via a network 400. The network 400 is a communication line network such as the Internet, an intranet, a cellular phone network, and a LAN (Local Area Network).

The route determination system 300 may include a plurality of the autonomous mobile bodies 100. Hereinafter, although the case in which the transport route is determined on the server 200 side will be described, the transport route may be determined on the autonomous mobile body 100 side.

The autonomous mobile body 100 includes a sensor 110, a communication unit 120, a travel control unit 130, and a temperature control unit 140. The sensor 110 collects environmental data around the autonomous mobile body 100 and outputs it to the travel control unit 130. The sensor 110 is, for example, a camera, radar, LIDAR, or the like. The communication unit 120 is a communication interface for performing wireless communication with the network 400. The communication unit 120 receives the transport route determined by the server 200 via the network 400. The communication unit 120 may transmit position information indicating a position of the autonomous mobile body 100 to the server 200.

The travel control unit 130 controls the autonomous mobile body 100 to autonomously move along the transport route using the environmental data collected by the sensor 110. Here, it is assumed that the autonomous mobile body 100 acquires the position of the autonomous mobile body 100 by GPS (Global Positioning System), the sensor 110, or the like. As described above, the transport route may be determined not on the server 200 side but on the autonomous mobile body 100 side. The temperature control unit 140 controls the temperature in a cargo room for loading articles.

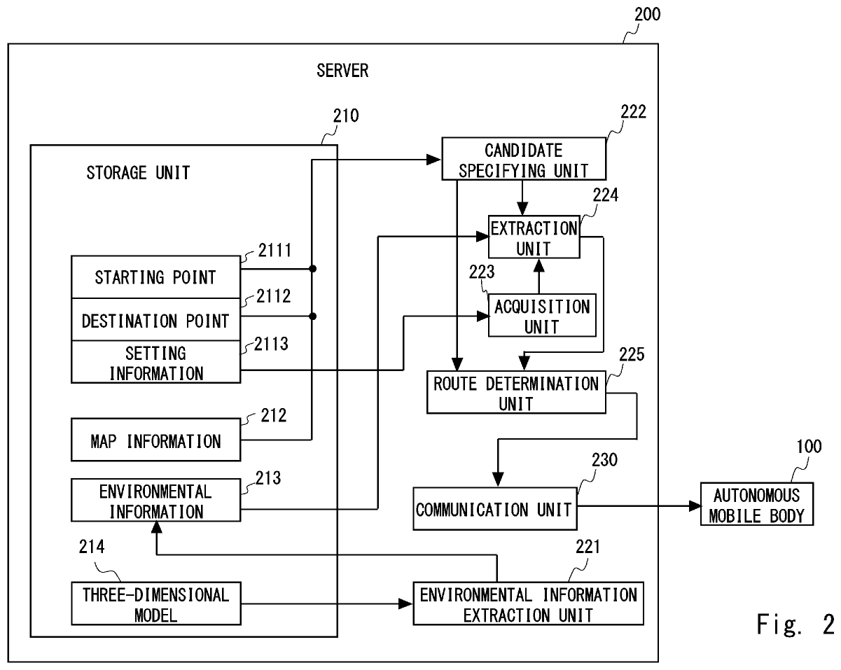

Next, the server 200 will be described in detail with reference to FIG. 2. The server 200 determines the transport route for the autonomous mobile body 100 to transport the package. The server 200 includes a storage unit 210, an environmental information extraction unit 221, a candidate specifying unit 222, an acquisition unit 223, an extraction unit 224, a route determination unit 225, and a communication unit 230.

The storage unit 210 is a storage apparatus such as a hard disk or a flash memory. The storage unit 210 may also include a volatile storage apparatus such as a RAM (Random Access Memory) which is a storage area for temporarily holding information. The communication unit 230 is a communication interface with the network 400.

The storage unit 210 stores a starting point 2111, a destination point 2112, setting information 2113, map information 212, environmental information 213, and a three-dimensional model 214. The storage unit 210 stores the starting point 2111, the destination point 2112, and the setting information 2113 related to the necessity of heat or cool retention in association with each other in transporting an article. The starting point 2111 may be a current position of the autonomous mobile body 100 received from the autonomous mobile body 100. Hereinafter, the case where the setting information 2113 is information about the necessity for cooling retention will be mainly described, and instead the setting information 2113 may be information about the necessity for heat retention.

The map information 212 is map data including a delivery area. The candidate specifying unit 222, which will be described later, specifies the candidate of the transport route using the map information 212. The map information 212 may be, for example, data of a road map in which nodes representing intersections and links representing passages are numbered. The map information 212 may be an environmental map showing an area of a building as an obstacle or the like.

The environmental information 213 is information indicating a low-temperature environment region in which a temperature in a delivery environment of the article is estimated to be lower than temperatures of other regions. The temperature in the delivery environment is the temperature associated with the delivery environment and may be, for example, the air temperature around the autonomous mobile body 100 or the temperature of the ground. The low-temperature environment region is, for example, a region to be shaded by a building. The three-dimensional model 214 is a three-dimensional model representing an environment around the delivery area. The environmental information extraction unit 221, which will be described later, extracts the environmental information 213 using the three-dimensional model 214.

The environmental information extraction unit 221 extracts the low-temperature environment region based on the three-dimensional model 214 and records the extracted low-temperature environment region as the environmental information 213. The environmental information extraction unit 221 extracts, for example, information indicating a shaded region. The environmental information extraction unit 221 may simulate an incident direction of sunlight at the present time, and extract the shaded region in the three-dimensional model 214 as the low-temperature environment region. Further, the environmental information extraction unit 221 may extract a region positioned right under a roof, an eaves or the like in the three-dimensional model 214 as the low-temperature environment region.

The candidate specifying unit 222 specifies a candidate of the transport route from the starting point 2111 to the destination point 2112 using the map information 212. At this time, the candidate specifying unit 222 uses a known algorithm. The candidate specifying unit 222 outputs the specified candidate of the transport route to the extraction unit 224 and the route determination unit 225.

The acquisition unit 223 acquires the setting information 2113 from the storage unit 210 and outputs it to the extraction unit 224.

When the setting information 2113 related to the necessity of cool retention is acquired from the acquisition unit 223, the extraction unit 224 extracts a low-temperature environment part in which the temperature in the delivery environment of the article along the candidate of the transport route is estimated to be lower than the temperatures of the other parts of the candidate. That is, the extraction unit 224 extracts a part of each candidate specified by the candidate specifying unit 222 which passes through the low-temperature environment region recorded as the environmental information 213. For example, the extraction unit 224 extracts a part of the candidate of the transport route passing through the shaded region. The extraction unit 224 outputs the extraction result for each transport route to the route determination unit 225.

The route determination unit 225 determines the transport route from among the plurality of candidates based on lengths of the low-temperature environment parts extracted by the extraction unit 224 so that the temperature in the delivery environment of the article becomes low. For example, the route determination unit 225 may determine, as the transport route, the candidate whose length of the low-temperature environment part extracted by the extraction unit 224 is longer than those of other candidates. Further, the route determination unit 225 may determine, as the transport route, the candidate having the longest proportion of the length of the low-temperature environment part from among the candidates. The route determination unit 225 transmits the determined transport route to the autonomous mobile body 100 via the communication unit 230.

The functions of the environmental information extraction unit 221, the candidate specifying unit 222, the acquisition unit 223, the extraction unit 224, and the route determination unit 225 may be implemented by a processor (not shown) reading and executing a program in the RAM.

The method for determining the transport route may be performed only under predetermined conditions. For example, the route determination system 300 may determine, as the transport route, the shortest route when the weather is cloudy or rainy, and may determine the transport route by the above-described processing when the weather is sunny. Furthermore, the route determination system 300 may determine, as the transport route, the shortest route at night and determine the transport route by the above-described processing in other times of the day.

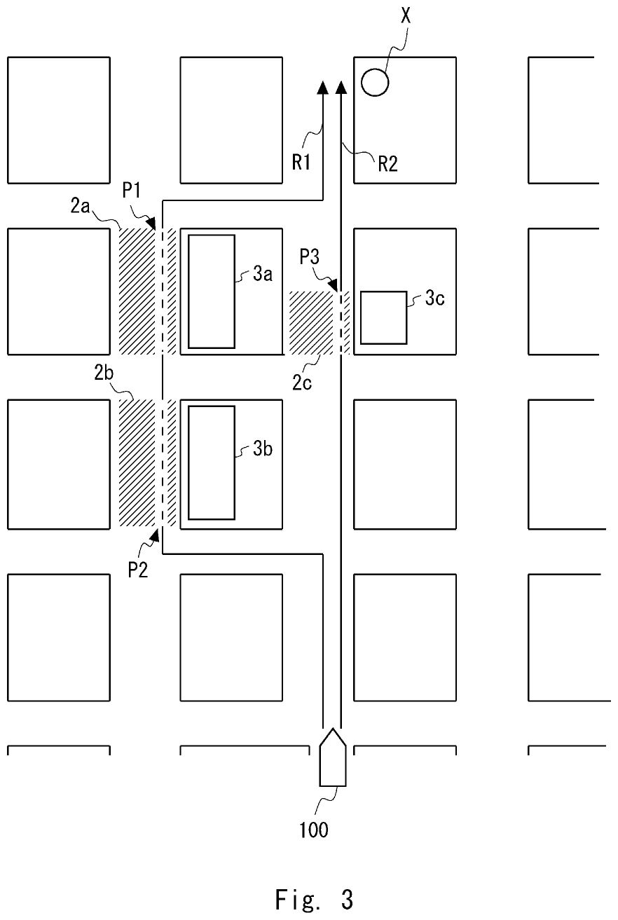

FIG. 3 is a schematic diagram showing an example of the transport route to be determined. The position of the autonomous mobile body 100 is set as the starting point, and a delivery destination X is set as a destination point. Then, it is assumed that regions 2a, 2b, and 2c which are shaded in FIG. 3 are recorded in the environmental information 213 as the low-temperature environment regions. The regions 2a, 2b, and 2c are regions shaded by structures 3a, 3b, and 3c, respectively.

Here, it is assumed that the candidate specifying unit 222 specifies candidates R1 and R2 using a known algorithm. Then, the extraction unit 224 extracts a part P1 of the candidate R1 passing through the region 2a and a part P2 of the candidate R1 passing through the region 2b. The extraction unit 224 extracts a part P3 of the candidate R2 passing through the region 2c. In FIG. 3, the parts P1, P2, and P3 are indicated by dotted lines. Since the sum of the lengths of the parts P1 and P2 is longer than the length of the part P3, the route determination unit 225 determines the candidate R1 as the transport route.

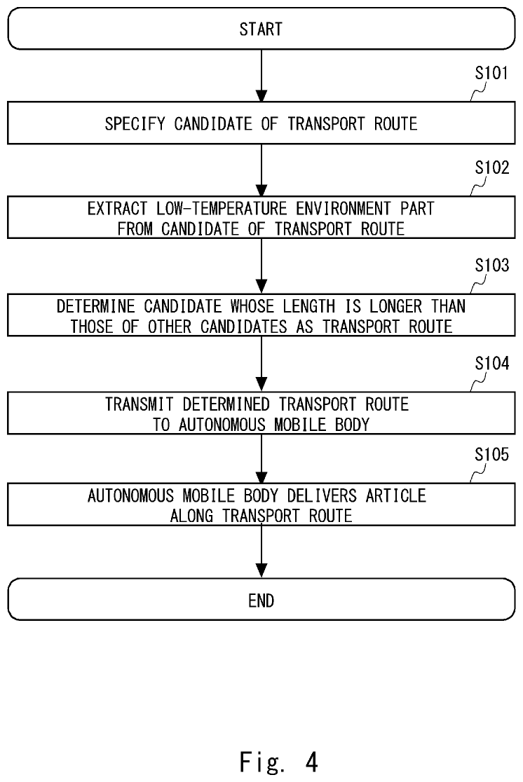

FIG. 4 is a flowchart showing an operation of the route determination system 300 according to the first embodiment. It is assumed that the acquisition unit 223 has acquired the setting information 2113 related to the necessity of the cool retention.

First, the route determination system 300 specifies the candidate of the transport route from the starting point 2111 to the destination point 2112 (Step S101). Here, the route determination system 300 may specify an appropriate candidate so that the transport route does not become too long. The starting point 2111 may be the current position of the autonomous mobile body 100 or a warehouse for storing delivery articles. The destination point 2112 is information indicating a delivery destination of the article.

Next, the extraction unit 224 extracts the low-temperature environment part which becomes the low-temperature environment along the candidate of the transport route specified in Step S101 (Step S102). It is considered that the longer the extracted part of the candidate is, the more suitable the transport route is for cooling the articles.

Next, the route determination unit 225 determines, as the transport route, the candidate whose length extracted by the extraction unit 224 in Step S102 is longer than those of other candidates (Step S103). Next, the server 200 transmits the determined transport route to the autonomous mobile body 100 (Step S104). When the autonomous mobile body 100 determines the transport route, the processing of Step S104 is not necessary. Finally, the autonomous mobile body 100 autonomously moves along the transport route acquired in Step S104, and delivers the article to the destination point 2112 (Step S105).

The route determination system 300 determines the transport route so that the temperature in the delivery environment of the article becomes low based on the length of the low-temperature environment part along the candidate of the transport route. Thus, the route determination system 300 can reduce the power consumption for the cooling retention.

In the above description, the case of the cooling retention is mainly described, but the present disclosure can also be applied to the case of heat retention. In the case of the heat retention, the extraction unit 224 extracts a high-temperature environment part in which the temperature in the delivery environment of the article along the candidate of the transport route is estimated to be higher than the temperatures of the other parts of the candidate. The route determination unit 225 determines the transport route from among the plurality of candidates based on the length of the high-temperature environment part so that the temperature in the delivery environment of the article becomes high.

Here, the high-temperature environment is, for example, a part passing through the sun. In other words, in the case of the heat retention, the route determination system 300 may determine, as the transport route, the candidate passing through more regions to be the sun than other candidates.

Although the case in which the server 200 determines the transport route has been described above, the autonomous mobile body 100 may acquire the information of the delivery destination, store the information of the shaded region, and determine the transport route from the current position to the delivery destination. That is, the processing performed by the extraction unit 224 and the route determination unit 225 may be performed on the autonomous mobile body 100 side. The autonomous mobile body 100 autonomously moves along the transport route determined by the autonomous mobile body 100 itself to deliver articles. In such a case, the route determination system 300 may not include the server 200. That is, a system in which the processing is completed within the autonomous mobile body 100 can also be included in the route determination system 300 according to the first embodiment.

### Second Embodiment

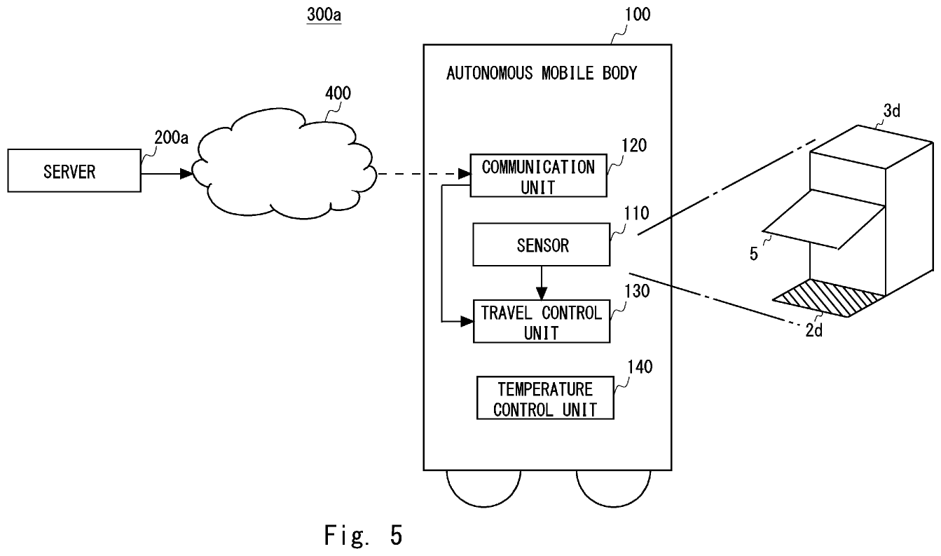

A route determination system 300a according to a second embodiment determines a low-temperature environment region based on a result of sensing performed by the autonomous mobile body 100 around the transport route. FIG. 5 is a configuration diagram showing a configuration example of the route determination system 300a. The route determination system 300a includes a server 200a and the autonomous mobile body 100. The autonomous mobile body 100 includes a camera as a sensor 110, and transmits a photographed image to the server 200a. It is assumed that a shaded region 2d or an eaves 5, a roof and the like of the structure 3d are photographed in the photographed image. It is assumed that the region right below the eaves 5 or the roof is shaded.

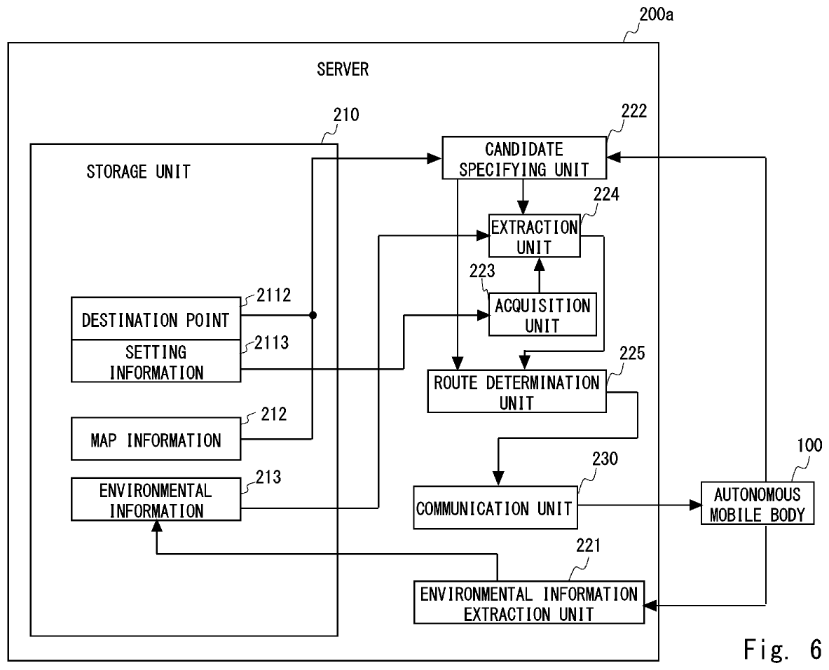

Next, a configuration of the server 200a will be described with reference to FIG. 6. Hereinafter, a difference between the second embodiment and the first embodiment will be mainly described. The environmental information extraction unit 221 acquires the photographed image from the autonomous mobile body 100, extracts information about the shaded region based on the photographed image, and records the information as the environmental information 213. A shaded position may be defined as a region in the passage that is darker than other regions of the passage. The shaded region may be defined as a region right below the roof and the eaves. The candidate specifying unit 222 specifies the candidate of the transport route from the current position received from the autonomous mobile body 100 to the destination point 2112. Since the processing of the extraction unit 224 and the route determination unit 225 are the same as those according to the first embodiment, the description thereof will be omitted.

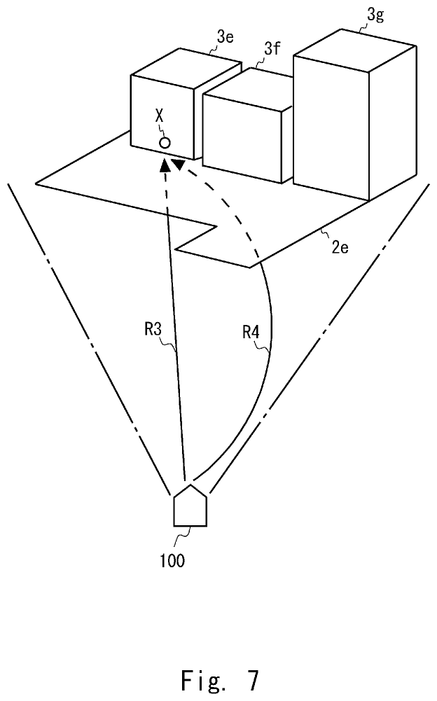

FIG. 7 is a schematic diagram showing an example of the transport route to be determined. The position of the autonomous mobile body 100 is set as the starting point, and the delivery destination X is set as the destination point. The autonomous mobile body 100 photographs the structures 3e to 3g and the shaded region 2e, and transmits the photographed image and the current position of the autonomous mobile body 100 to the server 200a. Note that, the eaves, roofs, etc. (not shown) of the structures 3e to 3g may be photographed in the photographed image. Here, the environmental information extraction unit 221 records the shaded region 2e as the environmental information 213.

The candidate specifying unit 222 specifies candidates R3 and R4. The extraction unit 224 extracts the low-temperature environment part of the candidate R3 passing through the region 2e. The extraction unit 224 extracts the low-temperature environment part which is a part of the candidate R4 passing through the region 2e. In the drawing, the low-temperature environment part is indicated by dotted lines. The route determination unit 225 determines the candidate R4 having a long low-temperature environment part as the transport route.

As described above, when the result of the sensing obtained by the autonomous mobile body 100 is used, the same effects as those of the first embodiment can be achieved. In the same manner as in the first embodiment, the autonomous mobile body 100 may record the shaded region, specify the candidate of the transport route from the current position to the delivery destination, and determine, as the transport route, the candidate having the low-temperature environment part longer than those of other candidates. In addition, by using the sunny region as the high-temperature environment region, the route determination system 300a according to the second embodiment can reduce the power consumption required for the heat retention.

### Third Embodiment

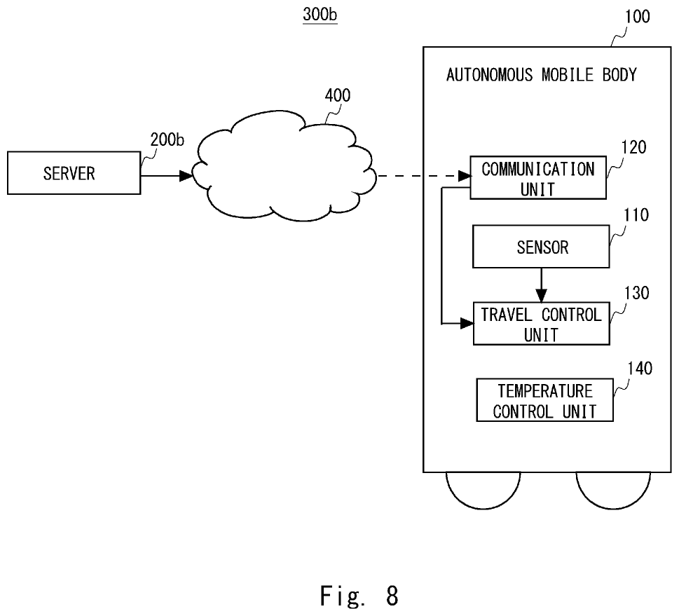

A route determination system 300b according to a third embodiment determines the transport route based on an air temperature distribution around the transport route. FIG. 8 is a configuration diagram showing a configuration example of the route determination system 300b. The route determination system 300b includes a server 200b and the autonomous mobile body 100. Since the system configuration of the route determination system 300b is the same as that shown in FIG. 1, a description thereof will be omitted.

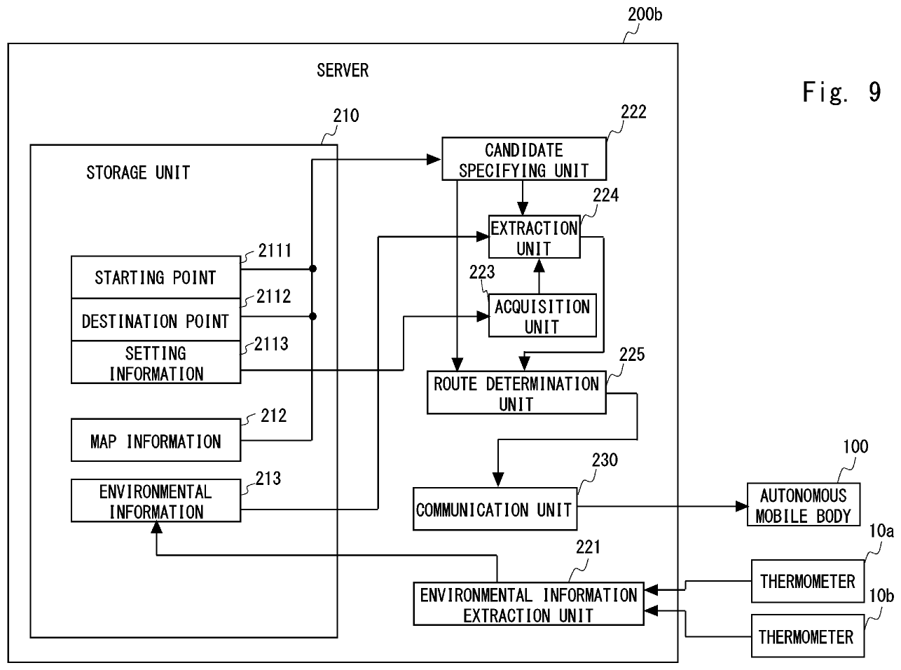

Next, the server 200b will be described with reference to FIG. 9. Hereinafter, a difference between the third embodiment and the first and second embodiments will be mainly described. The environmental information extraction unit 221 acquires the measurement results of the air temperature measured by thermometers 10a and 10b. Although only two thermometers are shown in FIG. 9, the server 200a may acquire the temperature information from three or more thermometers.

The thermometers 10a and 10b may be street thermometers installed on the streets. When an autonomous mobile body other than the autonomous mobile body 100 is present, the thermometers 10a and 10b may be air temperature sensors included in the other autonomous mobile body. The environmental information extraction unit 221 collects the positions of the thermometers 10a and 10b and the measurement results of the air temperature, extracts the low-temperature environment region in which the temperature in the delivery environment is estimated to be lower than the temperatures of other regions, and records the extracted low-temperature environment region as the environmental information 213. For example, the environmental information extraction unit 221 determines, as the low-temperature environment region, a predetermined range including the position of the thermometer that outputs a measurement value lower than a predetermined threshold. The threshold may be set appropriately in accordance with the set temperature of the cooling retention. The environmental information extraction unit 221 may extract the low-temperature environment region from information about the distribution of air temperatures in each region on the Internet or the like.

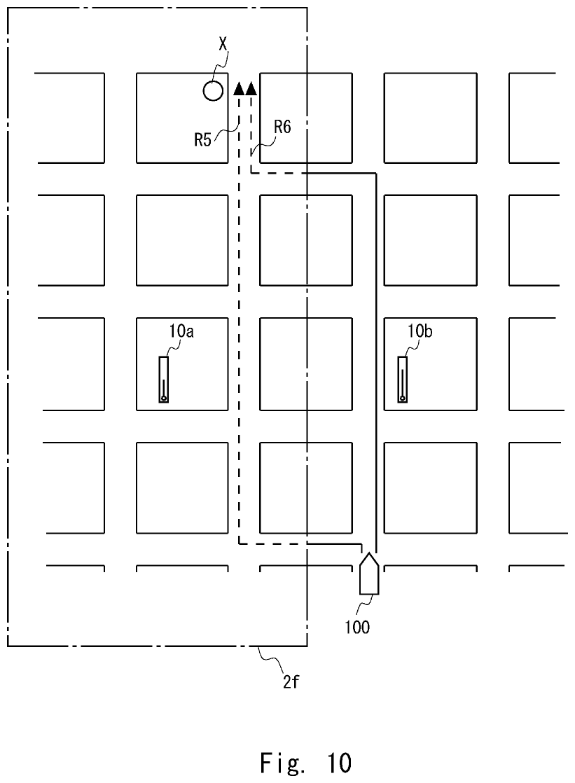

FIG. 10 is a schematic diagram showing an example of the transport route determined by the route determination system 300b. The position of the autonomous mobile body 100 is set as the starting point. The delivery destination X shall be the destination. From the measurement results of the thermometers 10a and 10b, it is assumed that the environmental information extraction unit 221 extracts a region 2f surrounded by the dashed-dotted line as the low-temperature environment region.

Under such premises, the candidate specifying unit 222 specifies candidates R5 and R6 of the transport route. The extraction unit 224 extracts the low-temperature environment part passing through the region 2f that is the low-temperature environment region along the candidate R5. In addition, the extraction unit 224 extracts the low-temperature environment part passing through the region 2f that is the low-temperature environment region along the candidate R6. Note that the low-temperature environment part is indicated by dotted lines. The route determination unit 225 determines, as the transport route, the candidate R5 whose extracted low-temperature environment part is long. According to this embodiment, the route passing through the low-temperature environment part can be determined as the transport route based on the distribution of the air temperature.

As described above, when the distribution of the air temperature is used, the same effects as those of the first and second embodiments can be achieved. In the same manner as in the first embodiment, the autonomous mobile body 100 may acquire the information of the air temperature distribution, specify the candidate of the transport route from the current position to the delivery destination, and determine, as the transport route, the candidate having a low-temperature environment part longer than those of other candidates. In a manner similar to the first and second embodiments, the route determination system 300b according to the third embodiment can also be used to reduce the power consumption for the heat retention.

Although the above embodiments have been described as a hardware configuration, the present disclosure is not limited thereto. The present disclosure may be realized by causing a CPU to execute a computer program for executing specified processing.

In the above example, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the embodiments described above, and may be appropriately modified without departing from the spirit thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A route determination system for determining a transport route for an autonomous mobile body to transport an article on from among a plurality of candidates, the route determination system comprising:
an acquisition unit configured to acquire setting information related to necessity of at least one of cooling retention and heat retention of the article;
an extraction unit configured to extract, for each of the plurality of candidates, a low-temperature environment part in which a temperature in a delivery environment of the article along the candidate is estimated to be lower than temperatures of other parts of the candidate when the setting information about the cooling retention is acquired, or a high-temperature environment part in which the temperature is estimated to be higher than temperatures of other parts of the candidate when the setting information about the heat retention is acquired; and
a route determination unit configured to determine the transport route from among the plurality of candidates so that the temperature in the delivery environment of the article becomes low based on a length of the low-temperature environment part when the setting information about the cooling retention is acquired, and determine the transport route from among the plurality of candidates so that the temperature in the delivery environment of the article becomes high based on a length of the high-temperature environment part when the setting information about the heat retention is acquired.

2. The route determination system according to claim 1, wherein
the extraction unit is configured to extract the low-temperature environment part or the high-temperature environment part based on a three-dimensional model obtained by modelling a surrounding region of the candidate.

3. The route determination system according to claim 2, wherein
the extraction unit is configured to extract the low-temperature environment part or the high-temperature environment part based on a result of a simulation of incidence of sunlight using the three-dimensional model.

4. The route determination system according to claim 1, wherein
the extraction unit is configured to extract the low-temperature environment part or the high-temperature environment part based on sensing data collected by the autonomous mobile body.

5. The route determination system according to claim 1, wherein
the extraction unit is configured to extract the low-temperature environment part or the high-temperature environment part based on a temperature distribution of a surrounding region of the candidate.

6. A route determination method for determining a transport route for an autonomous mobile body to transport an article on from among a plurality of candidates, the route determination method comprising:
acquiring setting information related to necessity of at least one of cooling retention and heat retention of the article;
extracting, for each of the plurality of candidates, a low-temperature environment part in which a temperature in a delivery environment of the article along the candidate is estimated to be lower than temperatures of other parts of the candidate when the setting information about the cooling retention is acquired, or a high-temperature environment part in which the temperature is estimated to be higher than temperatures of other parts of the candidate when the setting information about the heat retention is acquired; and
determining the transport route from among the plurality of candidates so that the temperature in the delivery environment of the article becomes low based on a length of the low-temperature environment part when the setting information about the cooling retention is acquired, and determining the transport route from among the plurality of candidates so that the temperature in the delivery environment of the article becomes high based on a length of the high-temperature environment part when the setting information about the heat retention is acquired.

7. A non-transitory computer readable medium storing a route determination program for determining a transport route for an autonomous mobile body to transport an article on from among a plurality of candidates, the route determination program causing a computer to execute:
acquiring setting information related to necessity of at least one of cooling retention and heat retention of the article;
extracting, for each of the plurality of candidates, a low-temperature environment part in which a temperature in a delivery environment of the article along the candidate is estimated to be lower than temperatures of other parts of the candidate when the setting information about the cooling retention is acquired, or a high-temperature environment part in which the temperature is estimated to be higher than temperatures of other parts of the candidate when the setting information about the heat retention is acquired; and
determining the transport route from among the plurality of candidates so that the temperature in the delivery environment of the article becomes low based on a length of the low-temperature environment part when the setting information about the cooling retention is acquired, and determining the transport route from among the plurality of candidates so that the temperature in the delivery environment of the article becomes high based on a length of the high-temperature environment part when the setting information about the heat retention is acquired.
